(19) United States
(12) Patent Application Publication
(10) Pub. No.: US 2003/0200178 A1
(43) Pub. Date: Oct. 23, 2003

(54) Managing licensing of distributed applications

(75) Inventors: Marvin J. Rich, Poughkeepsie, NY (US); William K. Mellors, Clinton Corners, NY (US); Soon I. Joe, Hopewell Junction, NY (US)

Correspondence Address: HESLIN ROTHENBERG FARLEY & MESITI PC, 5 COLUMBIA CIRCLE, ALBANY, NY, 12203, US

(73) Assignee: International Business Machines Corporation, Armonk, NY (US)

(21) Appl. No.: 10/125,243

(22) Filed: Apr. 18, 2002

(51) Int. Cl. G06F 17/60

(52) U.S. Cl. 705/59

(57) ABSTRACT

A licensed is obtained by an instance of a distributed application, and one or more other instances of the application are managed under the license. Collectively, the instances managed under the license behave as a single application. For instance, there is one point of user interaction, one point of input/output control, and one point of display for the collection of instances. Each of the controls can be the responsibility of one instance or distributed among various instances.

### TECHNICAL FIELD

This invention relates, in general, to software licensing and, in particular, to managing a plurality of instances of an application under a single license.

### BACKGROUND OF THE INVENTION

Licenses are used to grant permission to applications to execute within a communications environment. As technology and computer processing have advanced, so have the licenses and licensing protocols used to manage the applications arising therefrom. For example, one licensing protocol that has been utilized includes providing a license for an application that specifies that the application is to run on a particular computer. Thus, the application is tied to that computer via the license. This protocol, however, has proven inadequate for various types of applications, and therefore, other licensing protocols have emerged.

As one example, a licensing protocol has emerged for distributed applications, in which the license for a particular distributed application allows instances of the application to be processed on different systems within the environment, but the number of instances of the application that can be executing at any one time is limited. With this licensing protocol, each instance of the distributed application obtains a license from a license server. Thus, there are possibly many licenses to be managed.

Further, each instance of the application is treated as an independent instance, in that each instance communicates with the license server, can be a point of user interaction, can be an input/output control and can be a display point. Thus, each license that is obtained is a full license granting full capabilities. With many distributed applications, however, full capabilities are not needed for all of the instances of an application. For example, it may be that many of the instances are to just perform certain tasks for the application, such as providing computational power. In those cases, a full license for each instance is too costly for what is desired.

Based on the foregoing, a need exists for a capability that facilitates licensing of applications. In particular, a need exists for a capability that facilitates licensing of distributed applications. A further need exists for a capability that reduces the number of licenses to be managed for a distributed application. A yet further need exists for a capability that does not require each instance of an application to obtain a full license.

### SUMMARY OF THE INVENTION

The shortcomings of the prior art are overcome and additional advantages are provided through the provision of a method of managing licensing of applications of a communications environment. The method includes, for instance, obtaining a license for an instance of an application; and managing under the license one or more other instances of the application, wherein one or more capabilities of the one or more other instances of the application are controlled by the instance of the application.

In a further aspect of the present invention, a method of managing licensing of applications is provided. The method includes, for instance, obtaining a license for an application; and managing under the license a plurality of instances of the application, wherein the plurality of instances of the application collectively behave as one application.

In yet another aspect of the present invention, a method of dynamically selecting a licensing protocol is provided. The method includes, for instance, determining whether an instance of an application includes a chosen licensing option; and dynamically selecting a licensing protocol for the application in response to the determining.

System and computer program products corresponding to the above-summarized methods are also described and claimed herein.

Advantageously, one or more aspects of the present invention enable a plurality of instances of an application to be managed under a single license. One of the instances of the application obtains a license from a license server, and that instance manages the other instances. For example, that instance manages permissions granted to the other instances. This type of licensing management protocol is less costly in terms of network traffic to the license server, reduces the number of licenses to manage, and overall facilitates licensing of distributed applications.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one embodiment of a communications environment incorporating and using one or more aspects of the present invention;

FIG. 2 depicts one embodiment of a plurality of application instances of a distributed application accessing a license server to obtain a plurality of licenses;

FIG. 3a depicts one embodiment of a plurality of application instances of a distributed application, in which one instance of the plurality of instances manages other instances of the plurality of instances under a single license, in accordance with an aspect of the present invention;

FIG. 3b depicts one embodiment of an instance of a distributed application managing a plurality of instances of the application under a license; however, communication paths associated with the distributed application are provided by an instance other than the managing instance, in accordance with an aspect of the present invention;

FIG. 4 depicts one embodiment of the logic associated with managing a plurality of instances under a license, in accordance with an aspect of the present invention; and

FIG. 5 depicts one embodiment of the logic associated with dynamically selecting a licensing protocol, in accordance with an aspect of the present invention.

### BEST MODE FOR CARRYING OUT THE INVENTION

In accordance with an aspect of the present invention, licensing of distributed applications is facilitated. As one example, a license is obtained for one instance of the application (e.g., a master instance), and one or more other instances of the application (e.g., slave instances) are managed under the license. The one instance and the one or more other instances collectively behave as a single application managed under one license. For example, one of the instances being managed under the license provides the communication paths (e.g., interacts with the users, is a control point for input/output, and/or is a control point for display), while the other instances being managed under the license perform tasks for the application (e.g., provide computational power).

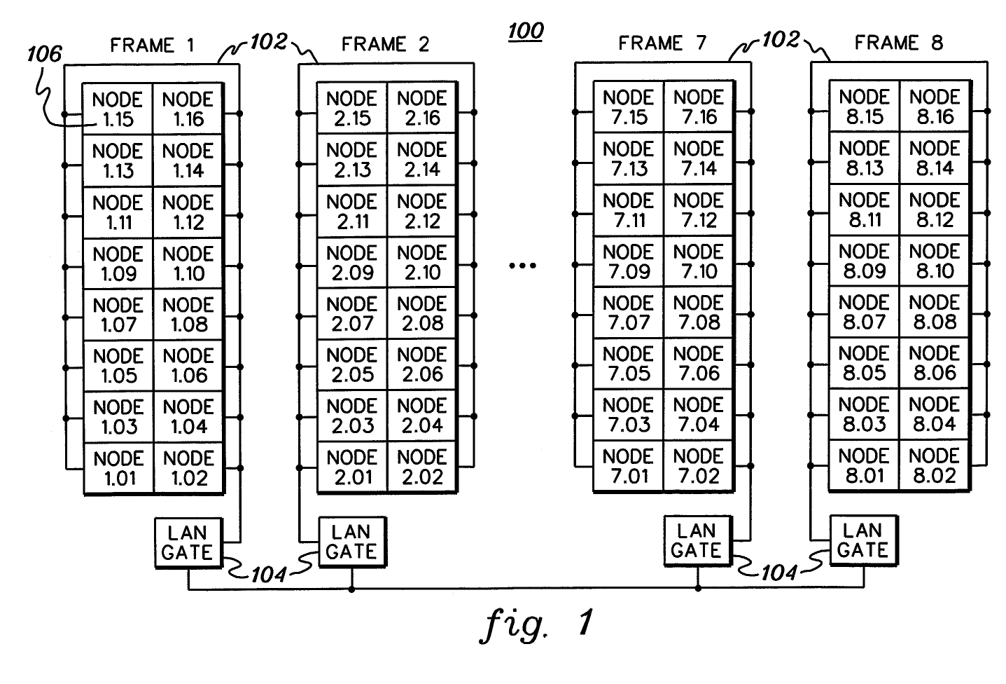

One embodiment of a distributed communications environment incorporating and using one or more aspects of the present invention is depicted in FIG. 1. In one example, a distributed computing environment 100 includes, for instance, a plurality of frames 102 coupled to one another via a plurality of LAN gates 104, each of which is described below.

In one example, distributed computing environment 100 includes eight (8) frames, each of which includes a plurality of processors 106 (a.k.a., processing nodes). In one instance, each frame includes sixteen (16) processors, and each processor is, for instance, a RISC/6000 computer running AIX, a UNIX based operating system. Each processor within a frame is coupled to the other processors of the frame via, for example, an internal LAN connection. Additionally, each frame is coupled to the other frames via LAN gates 104.

As examples, each LAN gate 104 includes either a RISC/6000 computer, any computer network connection to the LAN, or a network router. However, these are only examples. It will be apparent to those skilled in the relevant art that there are other types of LAN gates, and that other mechanisms can also be used to couple the frames to one another.

In addition to the above, the distributed computing environment of FIG. 1 is only one example. It is possible to have more or less than eight frames, or more or less than sixteen nodes per frame. Further, the processors do not have to be RISC/6000 computers running AIX. Some or all of the processors can include different types of computers and/or different operating systems. Further, other types of communications environments may be utilized. All of these variations are considered a part of the claimed invention.

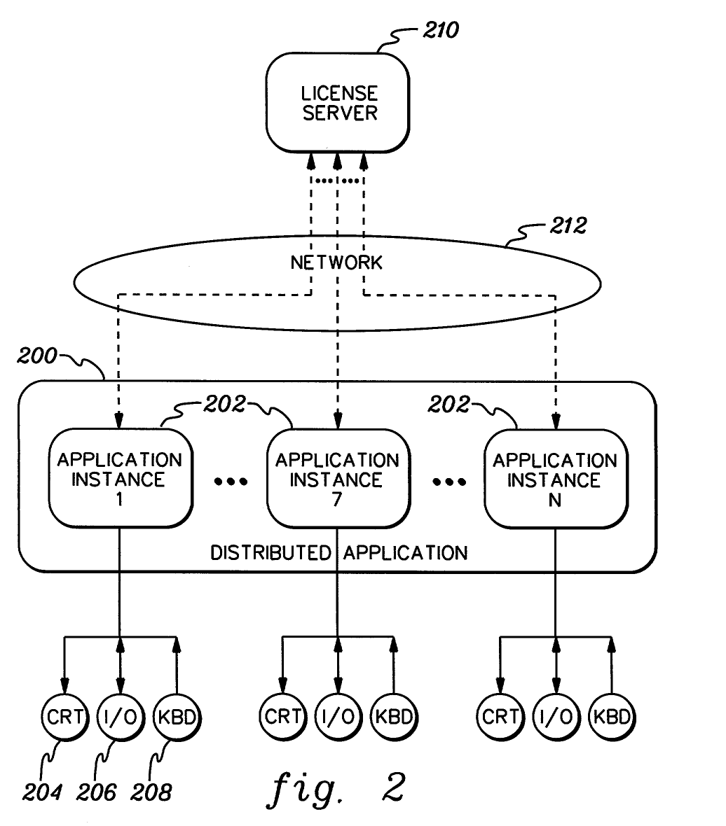

A communications environment can execute various types of applications, including distributed applications. A distributed application 200 (FIG. 2) includes, for example, a plurality of instances 202 to be processed on one or more processors of the environment. Conventionally, each instance of the application is an independent instance, having, for example, communications paths or capabilities, such as display (e.g., CRT) capabilities 204, control points for input/output 206, and keyboard capabilities 208 for user interaction. Thus, each independent instance is controlled under a separate license obtained via a license server 210 coupled to the instance through, for example, a network 212. Since each instance obtains a license, there is the possibility of having a large number of licenses to manage. Further, since each instance has full capabilities (e.g., each instance provides communications paths), each license is considered a full license.

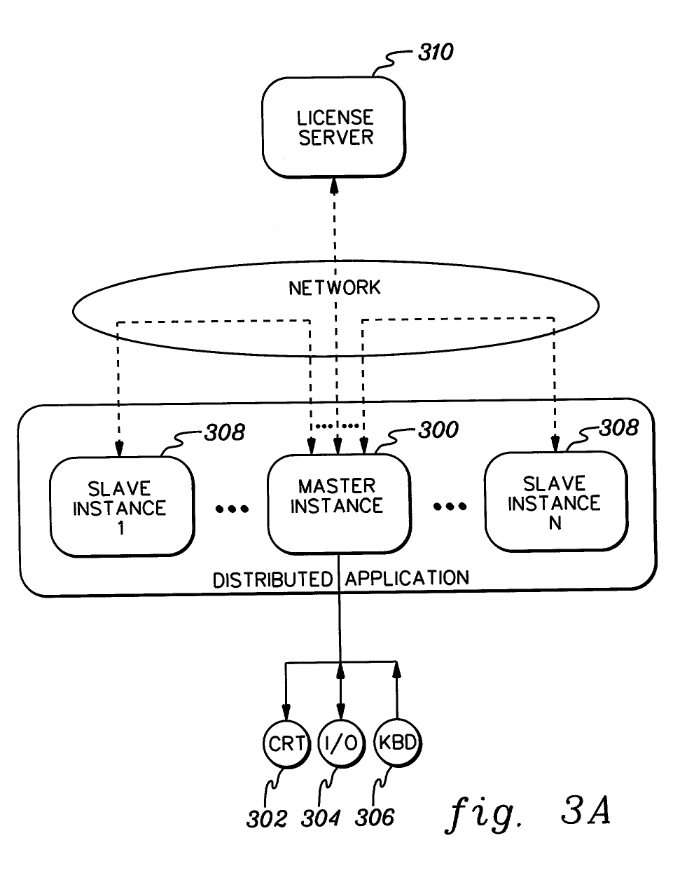

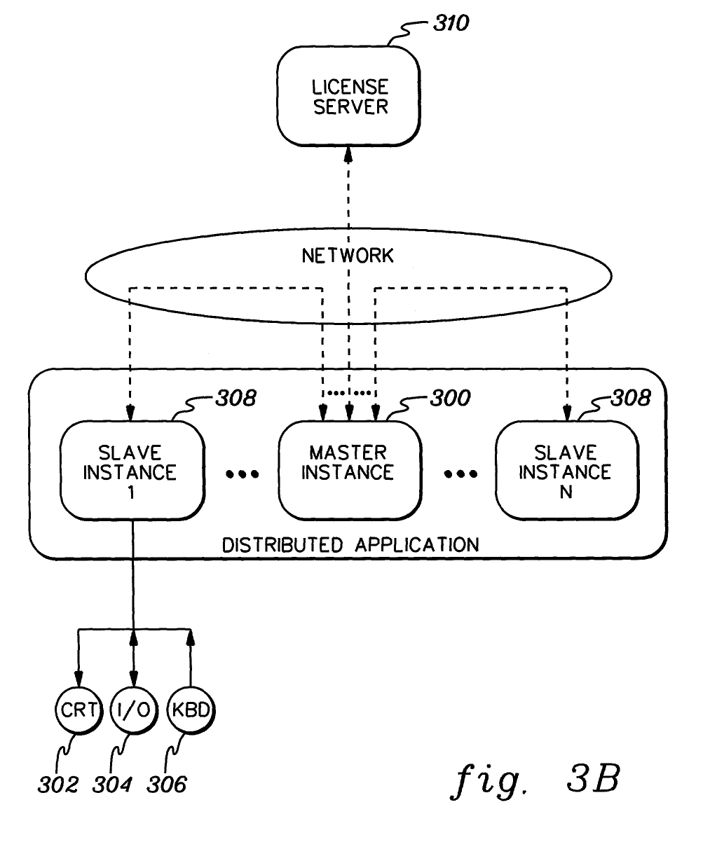

However, in some situations, such as with various distributed applications, full licensing capabilities are not needed or desired, and therefore, licensees may wish to have a scaled down license for a scaled down fee. In such a scenario, a set of instances of the application (e.g., one instance) has full capabilities and one or more of the other instances (e.g., the remaining instances) have reduced capabilities. For example, as shown in FIG. 3a, one instance 300 includes the communications paths for display capabilities 302, point of control for input/output 304, and user interaction capabilities 306. The other instances 308 do not include such capabilities. Instead, those instances perform one or more tasks for the one instance, such as providing computational power, etc. In this example, the one instance is referred to as the master instance and the other instances are referred to as slave instances. An instance of an application may include a copy of the entire application or a portion of the application.

In a further embodiment, it is possible that one or more of the communications path (e.g., the display, the input/output control, and/or user interaction) are not associated with the master instance, but one or more other selected instances managed under the license. For example, as shown in FIG. 3b, the master instance still has the responsibility of managing other instances under the license, but Slave Instance 1 is selected to provide the communications paths.

In yet another embodiment, the communications paths can be further distributed in that one or more of the paths can be with one instance and one or more of the other paths can be the responsibility of one or more other instances. For example, each of three instances may provide a path: one instance provides display capabilities; one instance provides input/output control; and one instance provides user interaction. In other embodiments, other combinations are also possible.

Although in the above scenarios the communications paths are distributed across the instances, the number of communications paths is restricted to the same number of paths as a single application. The distribution of the paths, however, enables the one or more processors with the best communication attributes to be utilized, in one aspect of the present invention.

The master instance of the distributed application is the instance, in one embodiment, that obtains (e.g., has, is provided, requests, etc.) a license for the application. In one example, the master instance obtains the license from license server 310, and the slave instances request permission to process from the master instance. The slave instances do not access the license server, and do not obtain separate licenses. They are managed under the one license.

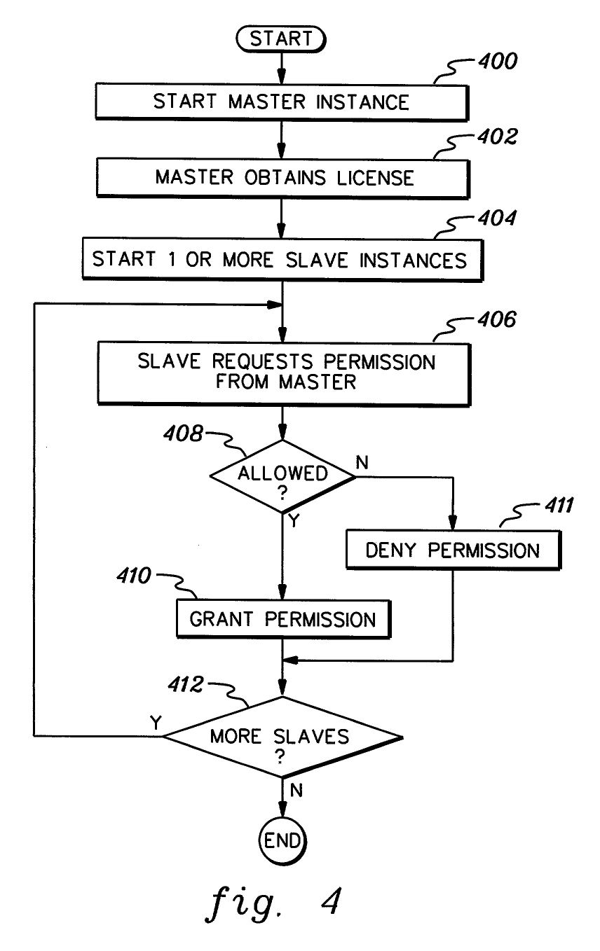

One embodiment of the logic associated with managing a plurality of instances under a single license is described with reference to FIG. 4. Initially, an instance of the application is started as the master instance, STEP 400. For example, the instance is started using a command, such as “Start pgM0 -master”. The keyword “master” indicates that this instance is to be the master instance. The master instance initializes itself and obtains a license. In one example, the master instance obtains the license by contacting the license server and requesting the license using, for instance, an appropriate license authorization. The license server determines that a master instance is requesting the license and grants the master instance a license that is appropriate for a master/slave relationship, STEP 402. The license server sends to the master instance an indication of the grant, as well as one or more terms, such as the number of permitted active slave instances, needed by the master to manage the slaves. The master then listens for slave requests.

Thereafter, one or more slave instances are started, STEP 404. In one example, each slave instance is started using a command, such as “Start pgm1 -MID pgm0”. The “-MID” option indicates that this instance is to be a slave to pgm0. Thus, the instance is programmed to know that it is to request permission to process from the master, rather than obtain a license from the license server. Therefore, each slave instance requests permission to execute from the master instance, STEP 406.

In response to a slave requesting permission from the master, the master determines whether the permission may be granted, INQUIRY 408. For example, the master determines whether the allowed number of slaves have already been granted permission. If not, then permission is granted from the master instance, STEP 410. Otherwise, permission is denied, STEP 411.

The master instance provides to the slave instance the capabilities for that slave. For example, the master may indicate that the slave is to perform computational power for the master (and therefore, the application), and that its other capabilities, such as its communications paths, are to be restricted. In response, the slave will disable its communications paths (e.g., display, input/output control, user interaction control point, etc.). For example, the application is not allowed to perform any output to display devices or DASD, as deemed appropriate, and/or input from the keyboard is ignored based on directives from the master instance.

In another example, the master may indicate that a slave is to perform one or more of the communications capabilities, as well as computations. Thus, the slave will disable only those paths that are not needed. Other variations are also possible.

Subsequent to granting permission, or if permission is denied, a determination is made as to whether there are more slave instances to be processed, INQUIRY 412. If there are more slave instances to be processed, then processing continues with STEP 406. Otherwise, processing is complete.

In one embodiment, as a slave terminates, the master is notified (e.g., by the slave, a control program, or other component), so that the master can properly keep track of the number of active slaves.

With the above capability, the master has the responsibility for enforcing one or more policies specified in the license. For example, the master grants permission to a slave instance, based on a quota policy, as described above. As a further example, the master gathers accounting information for itself, as well as for the slaves, for pricing, etc.

Further, with the above capability, a single point of presence for each of the communications paths (e.g., displays, user interaction, input/output control, as well as other possible paths or controls, such as human readable output files, etc.) is provided. As described herein, the single point of control can be a different point for the various paths or controls.

While in the above embodiments, a single license is obtained for a distributed application, it is also possible to have multiple masters for a particular distributed application, and therefore, multiple licenses, without reaching the one-to-one correspondence. For example, there may be twenty (20) instances of a distributed application with two (2) masters, one managing a set of slaves and the other managing another set of slaves. Other variations are also possible.

Further, in the above embodiments, a distributed environment is described. However, in other embodiments, a single processor may be used, in which the distributed application is distributed within the single processor.

In yet a further aspect of the present invention, the licensing protocol associated with the master/slave relationship is disabled, such that a conventional licensing protocol is used (e.g., the protocol described with reference to FIG. 2). The disabling/enabling mechanism is via the options specified when starting an application instance. For example, if “master” is designated, then the management protocol associated with the master/slave relationship is chosen. However, if that designation is missing, then a conventional protocol is selected.

Similarly, if “-MID” is specified by an instance, then that instance is designated a slave, and thus, the management protocol associated with the master/slave relationship is chosen. However, if “-MID” is missing, then a conventional protocol is selected. In one example, if “-MID” is specified and the id following the “-MID” option is not a master, then an error may be flagged or one of the protocols may be selected as a default.

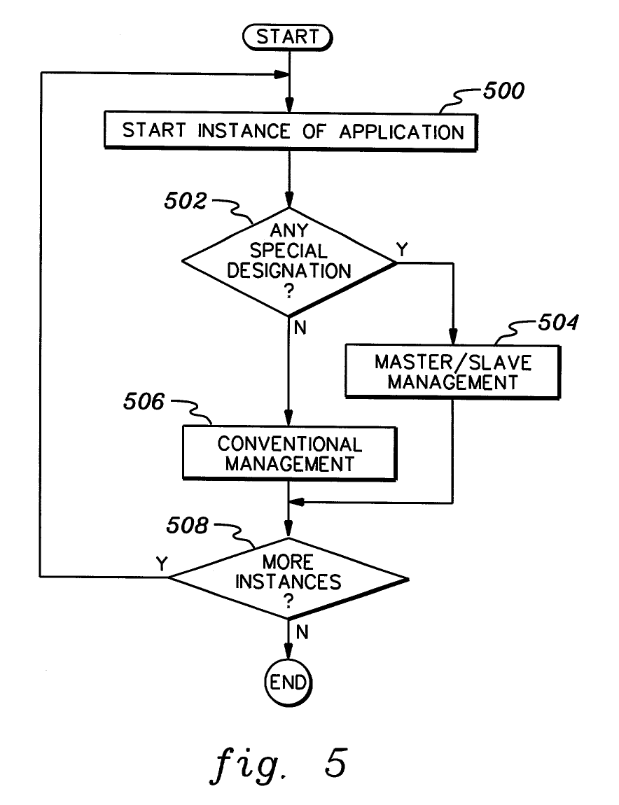

One embodiment of the logic associated with dynamically selecting a licensing protocol is described with reference to FIG. 5.

Initially, an instance of an application is started, STEP 500. In response to starting the application instance, a determination is made as to whether there is any special designation listed in the instance, INQUIRY 502. If the instance recognizes a special option, such as the master option or -MID, then the licensing protocol associated with the master/slave relationship is selected, STEP 504. Thus, if it is a master being started, then it will obtain an appropriate license from the license server. If it is a slave being started, then it will request permission from the designated master. However, if there is no special designation in the instance, then a conventional licensing protocol is selected, STEP 506.

Subsequently, if there are more instances to be started, INQUIRY 508, then processing continues with STEP 500. Otherwise, processing is complete.

Described in detail above is a capability for managing a collective set of instances of a distributed application under a single license. The management of licenses associated with distributed applications is facilitated, while enabling a distributed application to have more horsepower for an appropriate fee. The instances of the distributed application being managed collectively work on the same problem; however, various of the instances are not considered independent instances, since they lack one or more capabilities. For example, a slave instance may be provided with a restricted subset of its capabilities, as controlled by a master instance. A restriction may be on access to internal resources (e.g., log files, etc.) or external resources (e.g., keyboard, CRT, input/output control, etc.). The collection of the master instances and the one or more slave instances is viewed as a single application. For example, the computational configuration of the processors associated with processing the master and slave instances are bound as one logical software application.

The master instance may impart different access restrictions on itself or other slave instances, based on the computational needs of the collective, and the limits imposed by the license. This feature enforces restricted use of key resources defined by the license, but allows flexibility of usage of those restricted resources anywhere within the collective.

Advantageously, aspects of the present invention facilitate the use of different licenses to achieve a varied choice in pricing for processing power supported. For example, a single software distribution can operate in normal single user mode, or as a distributed master instance, or distributed slave instance. Different processing capabilities of the license structure can be appropriately priced with utilization of unique and/or quantized licensed capabilities. For example, several policies for establishing slaves in the collective computation with corresponding options for establishing prices include: 1) variable pricing based on real-time demand (price based on number of actual slaves used); 2) fixed rate pricing (price based on maximum number of slaves allowed); and 3) fixed plus premium for additional requirements above maximum (price based on maximum plus dynamic overflow of maximum).

The software license management capabilities of the present invention provide software vendors with the ability to consider an easy to implement and unbounded technique. Further, less overhead is required, since a reduced number of licenses (e.g., one) per distributed application need to be managed, and the pricing is according to capabilities enabled by the license.

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of managing licensing of applications of a communications environment, said method comprising:
obtaining a license for an instance of an application; and
managing under the license one or more other instances of the application, wherein one or more capabilities of the one or more other instances of the application are controlled by the instance of the application.

2. The method of claim 1, wherein the instance and the one or more other instances collectively behave as one application.

3. The method of claim 2, wherein computations performed by the one instance and the one or more other instances are collectively for the application.

4. The method of claim 1, wherein the controlling of the one or more capabilities for at least one instance of the one or more other instances comprises restricting access of the at least one instance to one or more resources.

5. The method of claim 1, wherein one instance of a collective of the instance and the one or more other instances is a point of input/output control for the collective.

6. The method of claim 1, wherein one instance of a collective of the instance and the one or more other instances is a point of user interaction for the collective.

7. The method of claim 1, wherein one instance of a collective of the instance and the one or more other instances is a display point for the collective.

8. The method of claim 1, wherein the obtaining comprises requesting by the instance the license from a license server.

9. The method of claim 8, wherein the requesting comprises indicating to the license server that the instance is a master instance, said master instance to manage permissions granted to the one or more other instances.

10. The method of claim 9, further comprising requesting by the one or more other instances from the master instance permission to process.

11. The method of claim 10, wherein the one or more other instances request permission as slave instances.

12. The method of claim 1, wherein said managing comprises controlling the number of one or more other instances to be currently active.

13. The method of claim 1, wherein the one or more other instances need not communicate with a license server for a license.

14. The method of claim 1, further comprising requesting by the one or more other instances from the instance permission to process.

15. The method of claim 1, wherein said obtaining comprises selecting a protocol for the license.

16. The method of claim 15, wherein said selecting is based on an option of the instance.

17. A method of managing licensing of applications, said method comprising:
obtaining a license for an application; and
managing under the license a plurality of instances of the application, wherein the plurality of instances of the application collectively behave as one application.

18. The method of claim 17, wherein the plurality of instances perform at least one computation for the application.

19. The method of claim 17, wherein the collectively behave as one application comprises having one instance of the plurality of instances provide an input/output control point.

20. The method of claim 17, wherein the collectively behave as one application comprises having one instance of the plurality of instances provide user interaction.

21. The method of claim 17, wherein the collectively behave as one application comprises having one instance of the plurality of instances provide a display point.

22. The method of claim 17, wherein the obtaining comprises requesting by one instance of the plurality of instances the license from a license server.

23. The method of claim 22, wherein the requesting comprises indicating to the license server that the one instance is a master instance.

24. The method of claim 22, further comprising requesting by other instances of the plurality of instances permission to process from the instance.

25. The method of claim 17, wherein each communications path of a plurality of communications paths of said application is restricted to one instance of the application.

26. The method of claim 17, wherein said obtaining comprises selecting a protocol for the license.

27. The method of claim 26, wherein said selecting is based on an option of at least one instance of the plurality of instances.

28. A method of dynamically selecting a licensing protocol, said method comprising:
determining whether an instance of an application includes a chosen licensing option; and
dynamically selecting a licensing protocol for the application in response to the determining.

29. The method of claim 28, wherein said dynamically selecting comprises selecting a master/slave protocol in response to the chosen licensing option including a master indication.

30. A system of managing licensing of applications of a communications environment, said system comprising:
means for obtaining a license for an instance of an application; and
means for managing under the license one or more other instances of the application, wherein one or more capabilities of the one or more other instances of the application are controlled by the instance of the application.

31. The system of claim 30, wherein the instance and the one or more other instances collectively behave as one application.

32. The system of claim 31, wherein computations performed by the one instance and the one or more other instances are collectively for the application.

33. The system of claim 30, wherein the controlling of the one or more capabilities for at least one instance of the one or more other instances comprises restricting access of the at least one instance to one or more resources.

34. The system of claim 30, wherein one instance of a collective of the instance and the one or more other instances is a point of input/output control for the collective.

35. The system of claim 30, wherein one instance of a collective of the instance and the one or more other instances is a point of user interaction for the collective.

36. The system of claim 30, wherein one instance of a collective of the instance and the one or more other instances is a display point for the collective.

37. The system of claim 30, wherein the means for obtaining comprises means for requesting by the instance the license from a license server.

38. The system of claim 37, wherein the means for requesting comprises means for indicating to the license server that the instance is a master instance, said master instance to manage permissions granted to the one or more other instances.

39. The system of claim 38, further comprising means for requesting by the one or more other instances from the master instance permission to process.

40. The system of claim 39, wherein the one or more other instances request permission as slave instances.

41. The system of claim 30, wherein said means for managing comprises means for controlling the number of one or more other instances to be currently active.

42. The system of claim 30, wherein the one or more other instances need not communicate with a license server for a license.

43. The system of claim 30, further comprising means for requesting by the one or more other instances from the instance permission to process.

44. The system of claim 30, wherein said means for obtaining comprises means for selecting a protocol for the license.

45. The system of claim 44, wherein the selecting is based on an option of the instance.

46. A system of managing licensing of applications, said system comprising:
means for obtaining a license for an application; and
means for managing under the license a plurality of instances of the application, wherein the plurality of instances of the application collectively behave as one application.

47. The system of claim 46, wherein the plurality of instances perform at least one computation for the application.

48. The system of claim 46, wherein the collectively behave as one application comprises means for having one instance of the plurality of instances provide an input/output control point.

49. The system of claim 46, wherein the collectively behave as one application comprises means for having one instance of the plurality of instances provide user interaction.

50. The system of claim 46, wherein the collectively behave as one application comprises means for having one instance of the plurality of instances provide a display point.

51. The system of claim 46, wherein the means for obtaining comprises means for requesting by one instance of the plurality of instances the license from a license server.

52. The system of claim 51, wherein the means for requesting comprises means for indicating to the license server that the one instance is a master instance.

53. The system of claim 51, further comprising means for requesting by other instances of the plurality of instances permission to process from the instance.

54. The system of claim 46, wherein each communications path of a plurality of communications paths of said application is restricted to one instance of the application.

55. The system of claim 46, wherein said means for obtaining comprises means for selecting a protocol for the license.

56. The system of claim 55, wherein the selecting is based on an option of at least one instance of the plurality of instances.

57. A system of dynamically selecting a licensing protocol, said system comprising:
means for determining whether an instance of an application includes a chosen licensing option; and
means for dynamically selecting a licensing protocol for the application in response to the determining.

58. The system of claim 57, wherein said means for dynamically selecting comprises means for selecting a master/slave protocol in response to the chosen licensing option including a master indication.

59. A system of managing licensing of applications of a communications environment, said system comprising:
a license for an instance of an application; and
one or more other instances of the application managed under the license, wherein one or more capabilities of the one or more other instances of the application are controlled by the instance of the application.

60. A system of managing licensing of applications, said system comprising:
a license for an application; and
a plurality of instances of the application managed under the license, wherein the plurality of instances of the application collectively behave as one application.

61. A system of dynamically selecting a licensing protocol, said system comprising:
at least one processor to determine whether an instance of an application includes a chosen licensing option; and
at least one processor to dynamically select a licensing protocol for the application in response to the determining.

62. At least one program storage device readable by a machine tangibly embodying at least one program of instructions executable by the machine to perform a method of managing licensing of applications of a communications environment, said method comprising:
obtaining a license for an instance of an application; and
managing under the license one or more other instances of the application, wherein one or more capabilities of the one or more other instances of the application are controlled by the instance of the application.

63. The at least one program storage device of claim 62, wherein the instance and the one or more other instances collectively behave as one application.

64. The at least one program storage device of claim 63, wherein computations performed by the one instance and the one or more other instances are collectively for the application.

65. The at least one program storage device of claim 62, wherein the controlling of the one or more capabilities for at least one instance of the one or more other instances comprises restricting access of the at least one instance to one or more resources.

66. The at least one program storage device of claim 62, wherein one instance of a collective of the instance and the one or more other instances is a point of input/output control for the collective.

67. The at least one program storage device of claim 62, wherein one instance of a collective of the instance and the one or more other instances is a point of user interaction for the collective.

68. The at least one program storage device of claim 62, wherein one instance of a collective of the instance and the one or more other instances is a display point for the collective.

69. The at least one program storage device of claim 62, wherein the obtaining comprises requesting by the instance the license from a license server.

70. The at least one program storage device of claim 69, wherein the requesting comprises indicating to the license server that the instance is a master instance, said master instance to manage permissions granted to the one or more other instances.

71. The at least one program storage device of claim 70, wherein said method further comprises requesting by the one or more other instances from the master instance permission to process.

72. The at least one program storage device of claim 71, wherein the one or more other instances request permission as slave instances.

73. The at least one program storage device of claim 62, wherein said managing comprises controlling the number of one or more other instances to be currently active.

74. The at least one program storage device of claim 62, wherein the one or more other instances need not communicate with a license server for a license.

75. The at least one program storage device of claim 62, wherein said method further comprises requesting by the one or more other instances from the instance permission to process.

76. The at least one program storage device of claim 62, wherein said obtaining comprises selecting a protocol for the license.

77. The at least one program storage device of claim 76, wherein said selecting is based on an option of the instance.

78. At least one program storage device readable by a machine tangibly embodying at least one program of instructions executable by the machine to perform a method of managing licensing of applications, said method comprising:
obtaining a license for an application; and
managing under the license a plurality of instances of the application, wherein the plurality of instances of the application collectively behave as one application.

79. The at least one program storage device of claim 78, wherein the plurality of instances perform at least one computation for the application.

80. The at least one program storage device of claim 78, wherein the collectively behave as one application comprises having one instance of the plurality of instances provide an input/output control point.

81. The at least one program storage device of claim 78, wherein the collectively behave as one application comprises having one instance of the plurality of instances provide user interaction.

82. The at least one program storage device of claim 78, wherein the collectively behave as one application comprises having one instance of the plurality of instances provide a display point.

83. The at least one program storage device of claim 78, wherein the obtaining comprises requesting by one instance of the plurality of instances the license from a license server.

84. The at least one program storage device of claim 83, wherein the requesting comprises indicating to the license server that the one instance is a master instance.

85. The at least one program storage device of claim 83, wherein said method further comprises requesting by other instances of the plurality of instances permission to process from the instance.

86. The at least one program storage device of claim 78, wherein each communications path of a plurality of communications paths of said application is restricted to one instance of the application.

87. The at least one program storage device of claim 78, wherein said obtaining comprises selecting a protocol for the license.

88. The at least one program storage device of claim 87, wherein said selecting is based on an option of at least one instance of the plurality of instances.

89. At least one program storage device readable by a machine tangibly embodying at least one program of instructions executable by the machine to perform a method of dynamically selecting a licensing protocol, said method comprising:
determining whether an instance of an application includes a chosen licensing option; and
dynamically selecting a licensing protocol for the application in response to the determining.

90. The at least one program storage device of claim 89, wherein said dynamically selecting comprises selecting a master/slave protocol in response to the chosen licensing option including a master indication.
